(19) United States
(12) Patent Application Publication
(10) Pub. No.: US 2005/0105388 A1
(43) Pub. Date: May 19, 2005

(54) Kit for use with paint cans containing paint

(76) Inventors: Jerome Fischman, Hong Kong (HK); Barbara Cooke, Hong Kong (HK)

Correspondence Address: THEODORE JAY, SUITE 600, 16 N CHATSWORTH AVE, LARCHMONT, NY, 10538, US

(21) Appl. No.: 10/713,181

(22) Filed: Nov. 14, 2003

(51) Int. Cl. B01F 7/00

(52) U.S. Cl. 366/247; 220/200

(57) ABSTRACT

A kit which enables quick and easy resealing of a can partially filled with paint without using the original lid. The kit incorporates manually operative stirring means available for immediate usage for stirring paint in a reopened can of paint.

### FIELD OF THE INVENTION

This invention is a kit intended for users in sealing, opening and closing, stirring and storing cans containing paint. It can also be used to pour paint as well as enabling a user to wipe excess paint from a brush.

### BACKGROUND OF THE INVENTION

After a person has removed the lid of a sealed can of paint and started painting, it is often necessary to stop painting with the can still containing a substantial amount of paint. To prevent the paint in the can from hardening and becoming unusable from continued exposure to air, the can has to be resealed as quickly as possible after use. The usual method of sealing the can is to replace the lid, but this is difficult to do and often causes paint dripping and spillage. Moreover, pouring paint directly from the can create undesired spillage.

The present invention is a kit which enables quick and easy resealing of a can partially filled with paint without using the original lid. This kit enables frequent use and resealing as required. Moreover, since paint in a reopened can has to be stirred before use, the kit incorporates manually operative stirring means available for immediate usage.

### SUMMARY OF THE INVENTION

Hence it is a primary object of this invention to provide a kit which enables quick and easy resealing of a can partially filled with paint without using the original lid.

It is another object of this invention to provide a kit of the character indicated which incorporates manually operative stirring means available for immediate usage for for stirring paint in a reopened can of paint.

These and other objects and advantages of this invention will either be explained or will become apparent hereinafter.

In accordance with the principles of this invention, a kit is adapted for manual insertion in and removable from a vertical paint can having an open top and containing paint.

The kit contains a vertical hollow tapered cylinder open at upper and lower ends. The lower end is adapted for removable engagement with the open top end of the paint can. The upper end of the cylinder is larger than the lower end of the cylinder and larger than the open top end of the can. The upper end of the cylinder has a spout adapted to pour paint.

A lid is provided for detachable air tight sealing engagement with the upper end of the cylinder and covering the spout.

Manually operative paint stirring means are provided and are securable within the cylinder and extend therebelow. The means includes a flat horizontal elongated member disposed between the upper and lower ends of the cylinder and secured to opposite inner walls of the cylinder and extending diametrically therebetween. A painter can remove excel paint from a brush by wiping it against this member.

The member has a centrally disposed first hole and the means includes a vertically elongated rod extendable through said hole. The rod has a lower end extending below the cylinder and terminating in paint stirring paddles. The rod has an upper end extending above the member and below the upper end of the cylinder. The upper end of the rod has a detachable handle which when manually rotated rotates the rod and mixes the paint. The handle may be detached from the upper end of the rod, turned upside down and reattached to the upper end of the rod so that it no longer extends above the top of the upper end of the cylinder. The detachable cylinder cover may be attached for secure air tight paint storage.

### BRIEF DESCRIPTION OF THE DRAWINGS

FIG. 1 is an exploded view of a preferred embodiment of the invention.

FIG. 2 is an enlarged detail view illustrating the installation of the handle on the rod.

FIG. 3 is a detail view of the handle.

FIG. 4 is a detail side view of the rod and

### DETAILED DESCRIPTION OF THE INVENTION

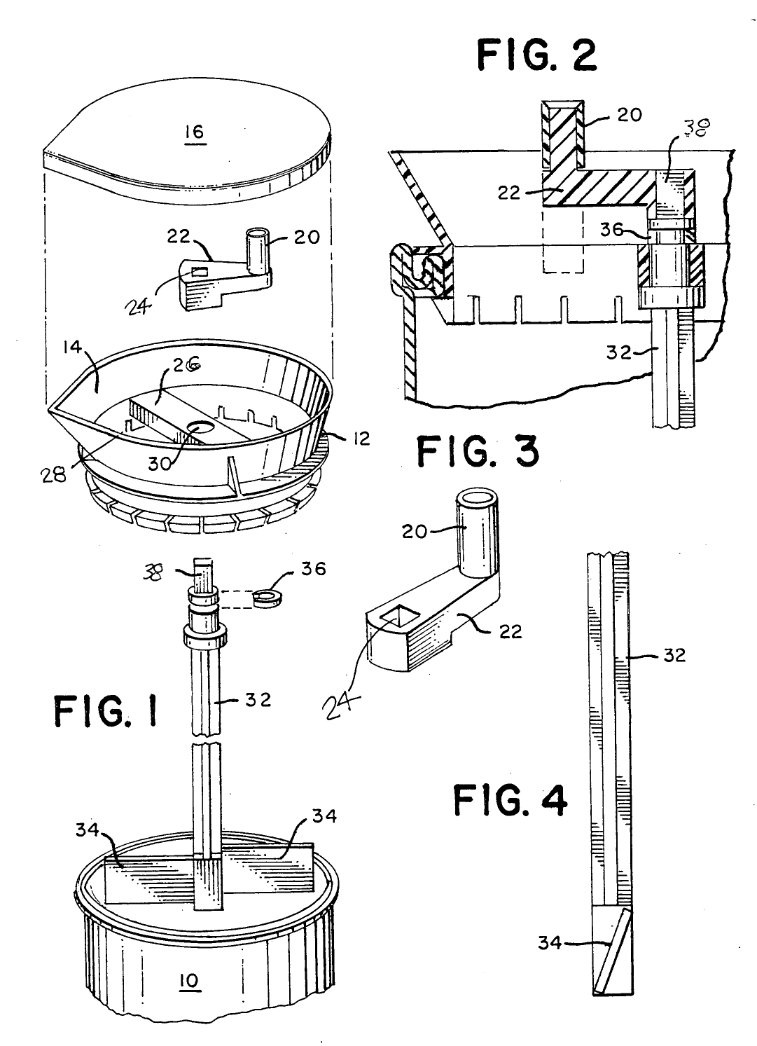

Referring now to FIGS. 1-4, 1 a kit is adapted for manual insertion in and removable from a vertical paint can 10 having an open top end and containing paint. The kit includes a vertical hollow tapered cylinder 12 open at upper and lower ends. The lower end of the cylinder is adapted for removable engagement with the open top end of the paint can. The upper end of the cylinder is larger than the lower end of the cylinder and larger than the open top end of the can. The upper end of the cylinder has a spout 14 adapted to pour paint.

A lid 16 is adapted for detachable sealing engagement with the upper end of the cylinder. The lid will cover the spout. A handle includes a elongated lever 20 connected at one end of a flat member 22. Member 22 has a square shaped hole 24.

Manually operative paint stirring means utilizes a horizontal elongated member 26 with opposite downwardly extending edges 28 disposed between the upper and lower ends of the cylinder. Member 26 is secured to opposite inner walls of the cylinder and extends diametrically therebetween.

Member 26 has a centrally disposed hole 30. The means includes a vertically elongated rod 32 of square shaped cross section extendable through hole 30. The rod has a lower end extending below the cylinder and terminates in paint stirring paddles 34. The rod has an upper end extending above the member and below the upper end of the cylinder. The upper end has a tip 38 of smaller size. A holding ring 36 secured to the upper end prevents undesired movement of the rod.

In use, member 22 is disposed so that its hole 24 tightly engages the tip 38 of the upper end of rod 32. When lever 20 is swung around in a horizontal circular path, it rotates the rod and mixes the paint.

As shown in phantom in FIG. 2, the handle structure may be detached from the upper end of the rod, turned upside down and reattached to the upper end of the rod so that it no longer extends above the top of the upper end of the cylinder and the detachable cylinder cover may be attached for secure air tight paint storage.

While the invention has been described with particular reference to the drawings and detailed description, the protection solicited is to be limited only by the terms of the claims which follow.

1. A kit adapted for manual insertion in and removable from a vertical paint can having an open top end and containing paint, said kit comprising:
a vertical hollow tapered cylinder open at upper and lower ends, the lower end being adapted for removable engagement with the open top end of the paint can, the upper end of the cylinder being larger than the lower end of the cylinder and larger than the open top end of the can, the upper end of the cylinder having a spout adapted to pour paint; and
a lid in detachable engagement with the upper end of the cylinder and covering the spout.

2. The kit of claim 1 further including manually operative paint stirring means securable within the cylinder and extending therebelow.

3. The kit of claim 2 wherein the means includes a horizontal elongated member disposed between the upper and lower ends of the cylinder and secured to opposite inner walls of the cylinder and extending diametrically therebetween.

4. The kit of claim 3 wherein said member has a centrally disposed first hole and said means includes a vertically elongated rod extendable through said hole, said rod having a lower end extending below the cylinder and terminating in paint stirring paddles, said rod having an upper end extending above the member and below the upper end of the cylinder, and a detachable handle which detachably engages the upper end of the rod and when manually rotated rotates the rod and mixes the paint

5. The kit of claim 4 wherein the handle may be detached from the upper end of the rod, turned upside down and reattached to the upper end of the road so that it no longer extends above the top of the upper end of the cylinder and the detachable cylinder cover may be attached for secure air tight paint storage.

6. the kit of claim 5 wherein the spout in the upper end of the cylinder is shaped to facilitate neat and clean pouring of paint.

7. The kit of claim 6 wherein a paint brush carrying excess pain can be wiped off using the horizontally elongated member.
